(19) United States
(12) Patent Application Publication
(10) Pub. No.: US 2012/0212747 A1
(43) Pub. Date: Aug. 23, 2012

(54) APPARATUS AND METHOD OF MEASURING SHAPE

(75) Inventor: Hiroyuki Yuki, Utsunomiya-shi (JP)

(73) Assignee: CANON KABUSHIKI KAISHA, Tokyo (JP)

(21) Appl. No.: 13/366,849

(22) Filed: Feb. 6, 2012

(30) Foreign Application Priority Data
Feb. 21, 2011 (JP) 2011-035181

(51) Int. Cl. G01B 11/24

(52) U.S. Cl. 356/511

(57) ABSTRACT

An apparatus for measuring a shape of a surface comprises: a measurement head including a division unit that divides light into reference light and test light, a reference surface, a light-condensing unit that condenses the test light onto the surface, and a first detector that detects interfering light between the test light Cat's Eye-reflected by the surface and the reference light reflected by the reference surface; a driving unit that drives the measurement head along the surface; a second detector that detects a position of the measurement head; and a processor that obtains a Gouy phase generated by diffraction of the test light on the surface, calculates a phase difference between the test light and the reference light based on information of the detected interfering light, and calculates the shape of the surface from the detected position of the measurement head, the obtained Gouy phase, and the calculated phase difference.

### BACKGROUND OF THE INVENTION

1. Field of the Invention

The present invention relates to an apparatus and method of measuring the shape of a surface to be measured.

2. Description of the Related Art

In recent years, an optical system mounted on a camera, a copying machine, a telescope, an exposure apparatus, or the like often uses aspherical optical elements such as aspherical lenses. It also uses, for example, an optical element having an adjustable curved surface shape and a diffraction optical element. Hence, an apparatus for measuring a shape needs to have a function of measuring the shapes of various surfaces to be measured. Japanese Patent Laid-Open No. 11-63945 discloses an apparatus for measuring a shape. This measurement apparatus irradiates a surface to be measured with light so as to form focus on it and measures the shape of the surface to be measured using light (test light) that returns due to so-called Cat's Eye reflection. In this measurement apparatus, reference light out of two light beams having slightly different frequencies is reflected by a reference surface. Test light is condensed on the surface to be measured using optical elements so as to cause Cat's Eye reflection. Interfering light between the reference light and the test light is detected. The shape of the surface to be measured is calculated based on the information of the detected interfering light.

In a measurement apparatus that measures a shape by scanning a measurement head (probe), a phase difference generated by the optical path length difference between reference light and test light is detected based on the information of detected interfering light. The measurement head is scanned, and at the same time, the position of the measurement head in the optical axis direction is controlled so as to obtain a constant phase difference. That is, the measurement head is controlled so as to obtain a constant optical path length difference. For this reason, the measurement head and the surface to be measured always maintain a constant distance. The shape of the surface to be measured can be calculated by detecting the position of the measurement head.

In fact, the phase difference also includes components caused by factors other than the optical path length difference, and some of them cause measurement errors. An example of the components that cause the measurement errors is a Gouy phase that is a phase shift caused by diffraction of test light. The Gouy phase is introduced on p. 1002 of J. Alda, “Laser and gaussian beam propagation and transformation”, in Encyclopaedia of Optical Engineering (Marcel Dekker, 2003), pp. 999-1013. Especially in a shape measurement apparatus using Cat's Eye reflection, light is condensed to focus on the surface to be measured. Hence, the Gouy phase remarkably changes in accordance with the local curvature of the light-condensing portion on the surface to be measured. In test light at this time, the phase difference generated the Gouy phase is added to the phase difference generated by the optical path length difference. Hence, if the Gouy phase changes as the measurement head scans, a measurement error in an equivalent amount occurs. For example, when measuring a surface to be measured whose local curvature is not constant the Gouy phase changes in accordance with the measurement portion, and the influence conspicuously appears.

### SUMMARY OF THE INVENTION

The present invention provides a technique advantageous for reducing measurement errors caused by the Gouy phase.

The present invention in its one aspect provides an apparatus for measuring a shape of a surface to be measured, comprising: a measurement head including a division unit that divides light emitted by a light source into reference light and test light, a reference surface that reflects the reference light, a light-condensing unit that condenses the test light onto the surface to be measured, and a first detector that detects interfering light between the test light Cat's Eye-reflected by the surface to be measured and the reference light reflected by the reference surface; a driving unit that drives the measurement head along the surface to be measured; a second detector that detects a position of the measurement head; and a processor that obtains a Gouy phase generated by diffraction of the test light on the surface to be measured, calculates a phase difference between the test light and the reference light based on information of the interfering light detected by the first detector, and calculates the shape of the surface to be measured from the position of the measurement head detected by the second detector, the obtained Gouy phase, and the calculated phase difference.

Further features of the present invention will become apparent from the following description of exemplary embodiments with reference to the attached drawings.

### BRIEF DESCRIPTION OF THE DRAWINGS

FIGS. 1A to 1C are flowcharts illustrating measurement procedures according to the first embodiment;

FIG. 2 is a view for explaining a measurement apparatus according to the first embodiment;

FIG. 3A is a view for explaining a measurement apparatus according to the second embodiment;

FIG. 3B is an enlarged view for explaining a part of a measurement head according to the second embodiment;

FIG. 4A is a view for explaining a measurement apparatus according to the third embodiment; and

FIG. 4B is a view for explaining a modification of the measurement apparatus according to the third embodiment.

### DESCRIPTION OF THE EMBODIMENTS

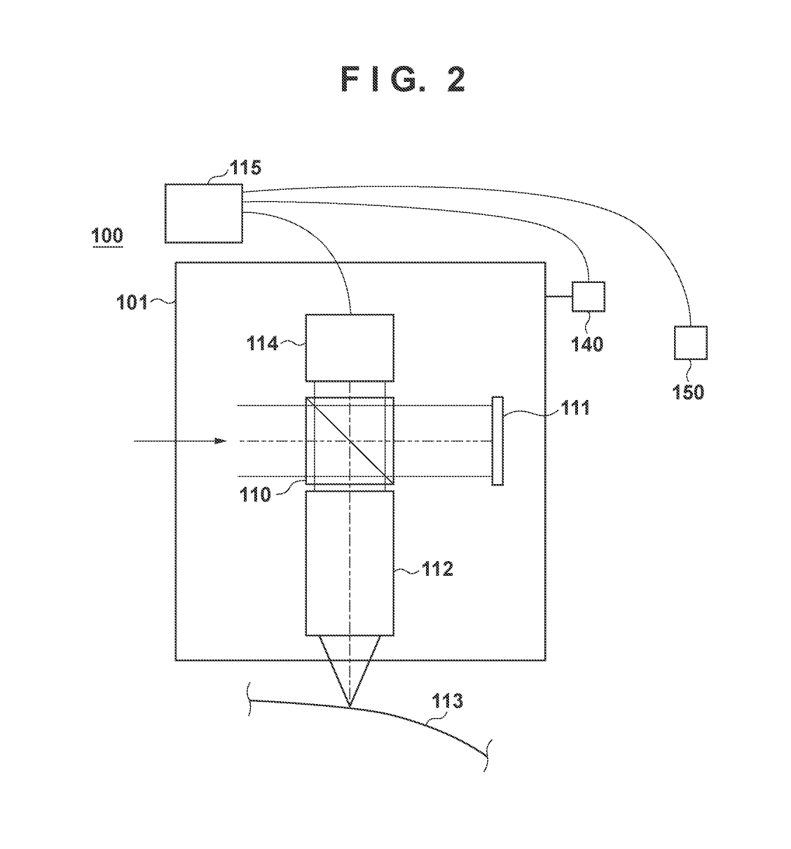

A measurement apparatus according to the present invention measures the shape of a surface to be measured of, for example, a lens, a mirror, or a mold used in, for example, a camera (including a video camera), a copying machine, a telescope, or an exposure apparatus. The local curvature of the surface to be measured changes between measurement points. The fundamental principles of the measurement apparatus according to the present invention will be described first with reference to FIG. 2. Note that the same reference numerals denote the same members throughout the drawings, and a repetitive description thereof will be omitted. FIG. 2 is a schematic sectional view showing an example of a measurement apparatus 100. The measurement apparatus 100 includes a measurement head 101, a driving unit 140 of the measurement head 101, a detector (second detector) 150 that detects the position of the measurement head 101, and a processor 115. The driving unit 140 drives the measurement head 101 along a surface 113 to be measured.

The measurement head 101 includes a division unit 110, a reference surface 111, a light-condensing unit 112, and a detector (first detector) 114 that detects interfering light between test light reflected by the surface 113 to be measured and reference light reflected by the reference surface 111. The division unit 110 divides light emitted by a light source (not shown) into reference light and test light. The light-condensing unit condenses the test light divided by the division unit 110 onto the surface 113 to be measured.

The light emitted by the light source is incident on the measurement head 101 and divided into two light beams by the division unit 110. One is reference light directed to the reference surface 111, and the other is test light directed to the surface 113 to be measured. The test light is condensed by the light-condensing unit 112 to focus on the surface 113 to be measured and returned to the light-condensing unit 112 by Cat's Eye reflection. Cat's Eye reflection is reflection of light condensed to one point on the surface 113 to be measured. The test light returned by the Cat's Eye reflection interferes with the reference light in the division unit 110, and the detector 114 detects the interfering light. The processor 115 calculates the phase difference between the test light and the reference light based on the interfering light detected by the detector 114. When scanning the measurement head 101 relative to the surface 113 to be measured, the relative distance between them changes. The optical path length of the test light changes when the relative distance between the measurement head 101 and the surface 113 to be measured changes. Hence, the phase difference between the test light and the reference light changes. The relative distance between the measurement head 101 and the surface 113 to be measured is controlled so as to obtain a constant phase difference. This makes it possible to obtain the information of the shape of the surface 113 to be measured.

The fundamental principles of the Gouy phase will be described next. The Gouy phase is generated when light is diffracted. For example, when forming a beam waist with a beam waist diameter ω₀ by light having a wavelength λ in a laser or Gaussian beam, a Gouy phase φ at a position apart from the beam waist by a distance z is given by

φ=arctan(λz/πΩ₀²) (1)

where π is the circular constant.

When a Gaussian beam is condensed on the surface 113 to be measured, a beam waist is formed on the surface 113 to be measured. Return light reflected by the surface 113 to be measured behaves as if it were a beam having the beam waist diameter ω₀ and emitted from a place apart from the surface 113 to be measured by a distance L due to the influence of the local curvature of the surface 113 to be measured at the condensing position (irradiation position) of the test light. Using a local radius R of curvature, the distance L and the beam waist diameter ω₀ are given by

$$\begin{matrix}L = \frac{2 {R ( π {ω}_{0}^{2} / λ )}^{2}}{{R}^{2} + 4 {( π {ω}_{0}^{2} / λ )}^{2}} & ( 2 ) \\ ω = \frac{R / 2}{\sqrt{{( R / 2 )}^{2} + {( π {ω}_{0}^{2} / λ )}^{2}}} & ( 3 )\end{matrix}$$

Hence, the Gouy phase φ′ generated by reflection on the surface to be measured having the local radius R of curvature is given by

φ′=arctan(λL/πω²) (4)

### First Embodiment

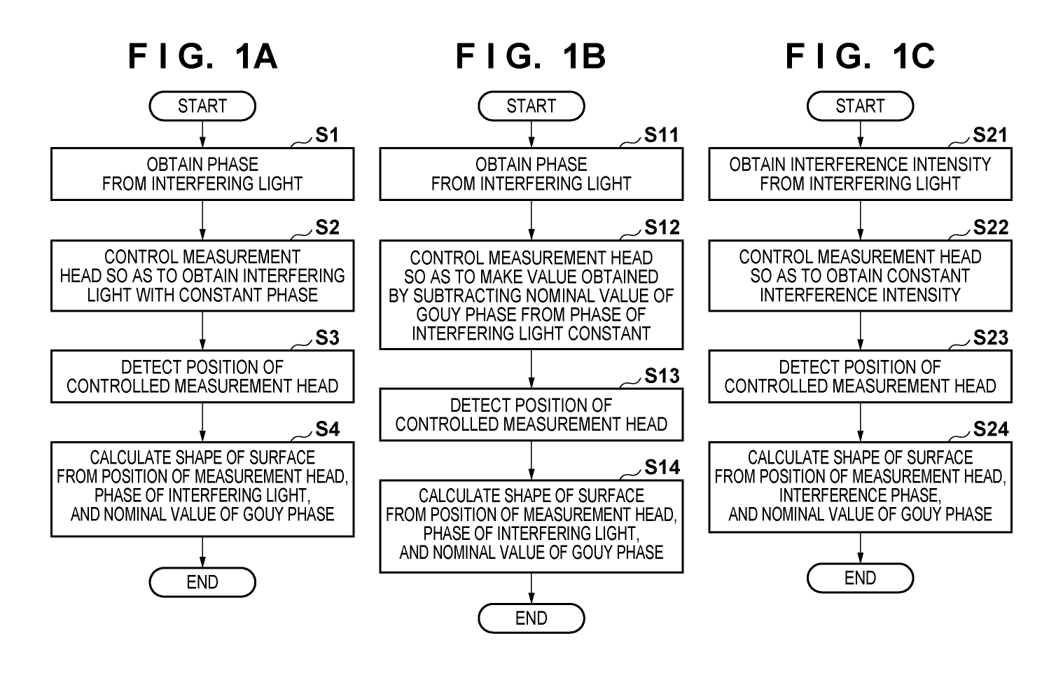

Measurement procedures according to the first embodiment using the measurement apparatus shown in FIG. 2 will be described based on FIGS. 1A to 1C. A measurement head 101 is controlled such that interfering light has a constant phase, as described above. The purpose is to always maintain a constant difference between the optical path length of reference light and that of test light. When the optical path length difference is maintained constant, the relative positions of the measurement head 101 and a surface 113 to be measured are always maintained constant. For this reason, a processor 115 can calculate the shape of the surface 113 to be measured by causing a detector 150 to detect the position of the measurement head 101 controlled in the above-described way.

The phase of the test light depends on not only its optical path length but also the Gouy phase generated by diffraction on the surface 113 to be measured. For example, when measuring two measurement points that have different local curvatures but the same distance between the measurement head 101 and the surface 113 to be measured, the Gouy phase of the test light takes different values at the respective measurement points based on the relationships given by equations (2) to (4). Since the Gouy phase takes different values, the phase of the interfering light takes different values. The control instruction value of the measurement head 101 changes when the phase of the interfering light changes. Hence, the measurement head 101 is controlled to different positions.

Hence, if the shape of the surface 113 to be measured is calculated based on only the position of the measurement head 101 after the control, different shapes are output for different local curvatures as the shape of the surface to be measured. This is measurement error caused by the Gouy phase. For example, when the surface 113 to be measured has a curvature, the local curvature changes as the measurement head 101 scans, and the above-described measurement errors occur. Especially in the structure using Cat's Eye reflection, the light is condensed to focus on the surface 113 to be measured. For this reason, the beam waist diameter is as small as 100 μm or less, and the generation amount and change rate of the Gouy phase therefore increase based on the relationships given by equations (2) to (4), resulting in large measurement errors. In the first embodiment, the measurement errors caused by the Gouy phase are reduced using the processor 115. FIG. 1A illustrates an example of the measurement procedure to be executed by the processor 115.

In step S1, the processor 115 obtains the phase from interfering light between test light and reference light detected by a detector 114. Note that although FIG. 2 illustrates a state in which parallel light is incident on the detector 114, the present invention is not limited to this. Non-parallel light such as converging light or diverging light may be incident on the detector 114 via an optical element (not shown). In this case, the position of the real or imaginary beam waist formed by the optical element (not shown) changes in accordance with the local curvature of the surface 113 to be measured. Hence, the Gouy phase is generated based on the real or imaginary beam waist formed by the optical element (not shown). The phase of the interfering light is obtained based on a beat signal by making the test light and the reference light have slightly different frequencies, as described in, for example, Japanese Patent Laid-Open No. 11-63945. However, the present invention is not limited to this. For example, the phase of the interfering light may be obtained by driving the reference surface 111 or the like to change the optical path length difference between the test light and the reference light.

In step S2, the processor 115 controls a driving unit 140 that drives the measurement head 101 to obtain interfering light with a constant phase. First, the position of the measurement head 101 is controlled such that the interfering light maintains a determined phase at the reference position on the surface 113 to be measured or a reference surface whose distance from the measurement head 101 is known in advance. As a result, the measurement head 101 can scan so that it always maintains a constant distance from the surface 113 to be measured.

In step S3, the processor 115 causes the detector 150 to detect the position of the controlled measurement head 101. Since the measurement head 101 always maintains a constant distance from the surface 113 to be measured by the control in step S2, the processor 115 can calculate the shape of the surface 113 to be measured based on the position of the measurement head 101 detected by the detector 150. In step S4, the processor 115 calculates the shape of the surface 113 to be measured based on the position data of the measurement head 101, the phase of the interfering light, and the nominal value of the Gouy phase obtained in advance. As described above, when the shape of the surface 113 to be measured is calculated based on only the position data of the measurement head 101 obtained in step S3, measurement errors occur due to the influence of the Gouy phase. For example, test light and reference light having slightly different frequencies are used, as in Japanese Patent Laid-Open No. 11-63945. In this case, using a phase 4 by the optical path length difference between the test light and the reference light and a Gouy phase G, the obtained phase of the interfering light is given by

Δφ+G (5)

If the measurement head 101 is controlled to make the value Δφ constant, the distance between the measurement head 101 and the surface 113 to be measured can be maintained constant. Actually, however, since the measurement head 101 is controlled to make the value of expression (5) constant, measurement errors occur. To prevent this, the processor 115 uses the nominal value of the Gouy phase obtained in advance. The processor 115 subtracts the nominal value from the phase of the detected interfering light to calculate the phase Δφ by the optical path length difference between the test light and the reference light, and converts the change amount of the phase Δφ into a geometrical distance. The processor 115 then outputs a value obtained by correcting the position data of the measurement head 101 detected by the detector 150 based on the geometrical distance. In another example, the processor 115 calculates the nominal value of the Gouy phase and the optical path length difference corresponding to the value and subtracts the geometrical distance of the optical path length difference from the position data of the measurement head 101. The processor 115 can calculate a shape with reduced measurement errors by the Gouy phase by the above-described methods.

The method of controlling the measurement head 101 and the method of calculating the shape of the surface 113 to be measured are not limited to those shown in FIG. 1A. For example, as shown in FIG. 1B, the processor 115 may subtract the nominal value of the Gouy phase from the obtained phase of the interfering light and control the position of the measurement head 101 using the driving unit 140 such that the phase value of the interfering light after the subtraction becomes constant (S12). The detector 150 detects the position of the controlled measurement head 101 (S13). Since the influence of the Gouy phase is eliminated in step S2, the processor 115 can calculate the shape after the measurement errors caused by the Gouy phase have been reduced (S14).

Both the above-described procedures can variously be changed in order to reduce the influence of measurement errors caused by the Gouy phase. Calculating the shape of the surface 113 to be measured based on three data, that is, the phase of the detected interfering light, the nominal value of the Gouy phase, and the position data of the measurement head 101 enables to calculate the shape after the measurement errors caused by the Gouy phase have been reduced.

The nominal value of the Gouy phase is the value of the Gouy phase stored in the storage unit of the processor 115 or calculated based on user input. For example, the value is calculated based on the nominal value of the surface 113 to be measured and the data of the beam waist of the test light which are input by the user, and stored in the storage unit of the processor 115. The nominal value of the surface 113 to be measured can be either the designed value of the shape of the surface 113 to be measured or less accurate shape data measured in advance. An example has been described above in which the position of the measurement head 101 is controlled to obtain interfering light with a constant phase. However, the present invention is not limited to this. As shown in FIG. 1C, the measurement head 101 may be driven to obtain interfering light with a constant intensity (S22).

### Second Embodiment

In the first embodiment, an example has been described in which the nominal value of the Gouy phase is calculated based on the nominal value of the surface 113 to be measured input by the user. However, in a measurement apparatus configured to, for example, irradiate part of the opening of the light-condensing unit 112 with test light, measurement errors caused by the Gouy phase can be reduced by controlling the Gouy phase itself. In the second embodiment, a Gouy phase controller 116 that controls the Gouy phase is further provided to actually control w and L of equation (4), thereby controlling the generation amount of the Gouy phase φ′ represented by equation (4).

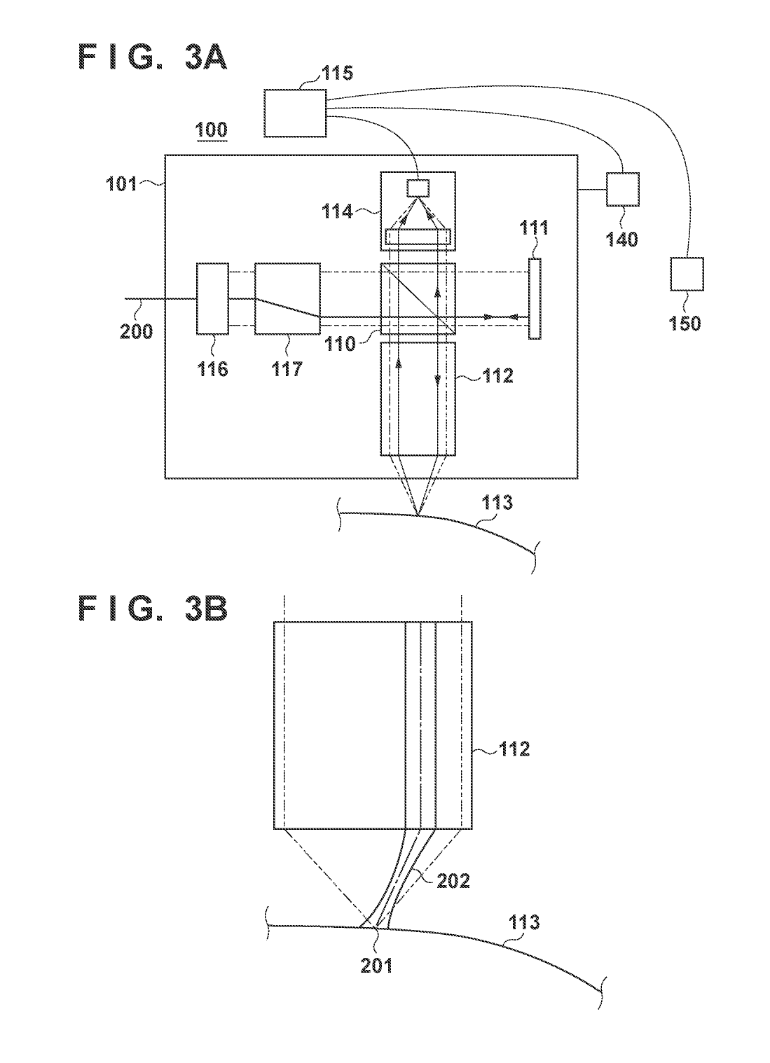

The Gouy phase controller 116 will be explained with reference to FIGS. 3A and 3B. FIG. 3A is a schematic sectional view showing an example of a measurement head 101. Light 200 incident on the measurement head 101 is controlled by a control mechanism 117 that controls the incident angle of reference light on a surface 113 to be measured, and condensed onto the surface 113 to be measured through part of the opening portion of a light-condensing unit 112. FIG. 3B is an enlarged sectional view showing the light-condensing unit 112, the surface 113 to be measured, and light controlled by the control mechanism 117. The Gouy phase controller 116 includes at least one of a control mechanism that controls the distance between a light-condensing position (irradiation position) 201 and a beam waist position 202 of test light on the surface to be measured and a control mechanism that controls the beam waist diameter of the test light, thereby controlling the Gouy phase.

The control mechanism that controls the distance between the light-condensing position 201 and the beam waist position 202 of the test light can be a control mechanism that controls, for example, the focal length to cause parallel light emitted by a light source to converge or diverge. The control mechanism that controls the beam waist diameter of the test light can be a control mechanism that controls an optical scaling factor.

Causing the Gouy phase controller 116 to control the distance between the light-condensing position 201 and the beam waist position 202 of the test light or the beam waist diameter of the test light to allow Gouy phase control will be described below. Let D be the distance between the light-condensing position 201 and the beam waist position 202 of the test light. Then, the distance L given by equation (2) is rewritten as

$$L = \frac{\frac{R}{2} \{ D ( \frac{R}{2} + D ) + {( π {ω}_{0}^{2} / λ )}^{2} \}}{{( \frac{R}{2} + D )}^{2} + {( π {ω}_{0}^{2} / λ )}^{2}} \qquad ( 6 )$$

At this time, w represented by equation (3) is rewritten as

$$ω = \frac{R / 2}{\sqrt{{( \frac{R}{2} + D )}^{2} + {( π {ω}_{0}^{2} / λ )}^{2}}} \qquad ( 7 )$$

This allow to control the distance L and the beam waist diameter ω₀ by controlling the distance D. It is therefore possible to actually control the generation amount of the Gouy phase φ′ represented by φ′=arctan(λL/πω²) of equation (4).

Hence, controlling the distance D or the beam waist diameter ω₀ allows to actually control the beam waist diameter ω₀ represented equation (3) or (7) and thus actually control the generation amount of the Gouy phase φ′ represented by equation (4).

The Gouy phase controller 116 can change the Gouy phase without changing the optical path length difference between the test light and the reference light. For example, it is possible to calculate the Gouy phase based on the change of the Gouy phase and use the calculated Gouy phase as the nominal value of the Gouy phase. In another example, the Gouy phase controller 116 controls the Gouy phase to almost π/2 that is a converging value, thereby calculating the Gouy phase.

As a technique of calculating the Gouy phase, controlling the optical path length of test light to change the optical path length difference between the test light and reference light is also known (see Japanese Patent No. 4279679). However, in this case, the test light cannot be condensed to focus on the surface 113 to be measured and cause Cat's Eye reflection. For this reason, the technique described in Japanese Patent No. 4279679 cannot be applied to the measurement apparatus according to the present invention. On the other hand, the above-described Gouy phase controller 116 is applicable to the measurement apparatus according to the present invention because it does not change the optical path length difference. When the procedure described in the first embodiment is performed using the calculated Gouy phase value as the nominal value of the Gouy phase, the measurement errors caused by the Gouy phase can be reduced. In FIG. 3A, the Gouy phase controller 116 is arranged before the control mechanism 117 for controlling the incident angle along the light traveling direction. However, the present invention is not limited to this.

### Third Embodiment

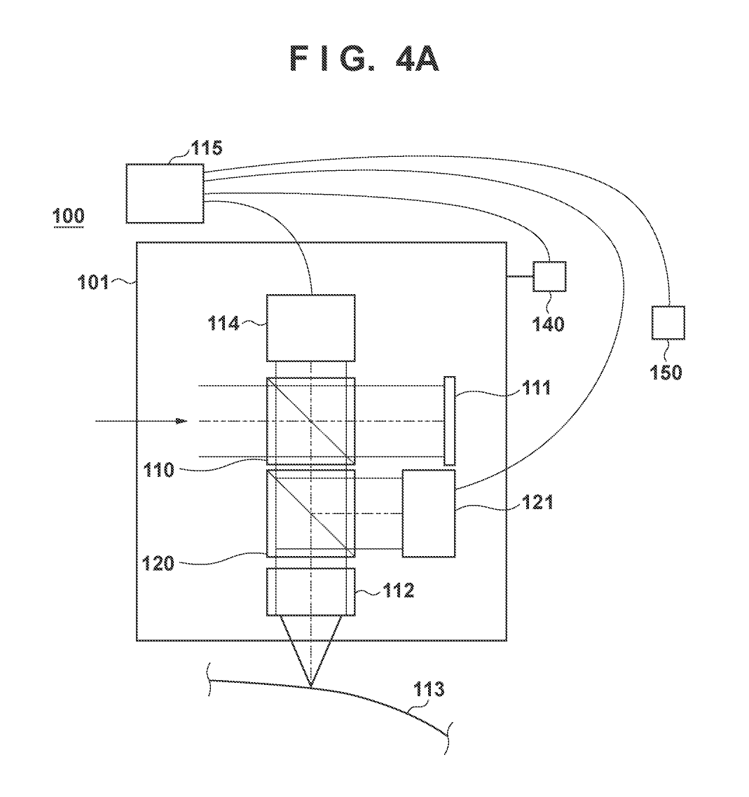

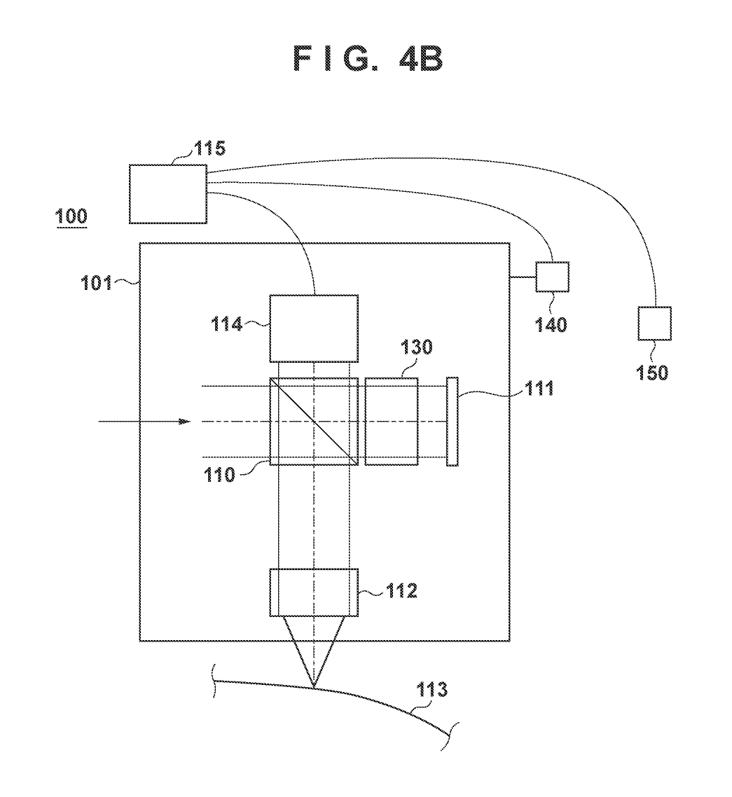

In the third embodiment, test light includes at least two light components that are different from each other. The Gouy phase is detected using interfering light between one and the other light components reflected by a surface 113 to be measured and used. This embodiment will be described below with reference to FIG. 4A. FIG. 4A is a schematic sectional view showing an example of a measurement head 101. Test light includes at least two different light components by a mechanism (not shown). The at least two different light components are, for example, Gaussian beams of different orders. One light component is a Gaussian beam of lower order, and the other is a Gaussian beam of higher order. The Gaussian beam of higher order can be, for example, either an Hermite-Gaussian beam of higher order mode or a Laguerre-Gaussian beam of higher order mode. The method of detecting the Gouy phase based on the interfering light between the Gaussian beam of lower order and the Gaussian beam of higher order is described in, for example, Jong H. Chow, Glennde Vine, Malcolm B. Gray, and David E. McClelland, “Measurement of Gouy phase evolution by use of spatial mode interference”, Opt. Lett. 29, 2339-2341 (2004). A detector (third detector) 121 detects the interfering light between the Gaussian beam of lower order and the Gaussian beam of higher order. A processor 115 calculates the Gouy phase from the interfering light detected by the detector 121. Using the calculated Gouy phase as the nominal value of the Gouy phase makes it possible to calculate the shape of the surface 113 to be measured while reducing the measurement errors caused by the Gouy phase.

In the measurement head 101 shown in FIG. 4A, a detector 114 that detects the interfering light between the test light and the reference light and the detector 121 that detects the interfering light between the Gaussian beam of lower order and the Gaussian beam of higher order are separately formed. However, the present invention is not limited to this. The two detectors may be formed as one detector 114, as shown in FIG. 4B.

FIG. 4B is a schematic sectional view showing an example of the measurement head 101. Test light includes at least two different light components by a mechanism (not shown). The detector 114 detects interfering light between the at least two different light components. To more accurately detect the interfering light between the at least two different light components, the transmittance of the reference light may be controlled by a control mechanism 130 that controls the reference light. The detector 114 detects the interfering light between a Gaussian beam of lower order and a Gaussian beam of higher order. The processor 115 calculates the Gouy phase from the interfering light. Using the calculated Gouy phase as the nominal value of the Gouy phase makes it possible to calculate the shape of the surface 113 to be measured while reducing the measurement errors caused by the Gouy phase.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-035181 filed Feb. 21, 2011, which is hereby incorporated by reference herein in its entirety.

What is claimed is:

1. An apparatus for measuring a shape of a surface to be measured, comprising:
a measurement head including a division unit that divides light emitted by a light source into reference light and test light, a reference surface that reflects the reference light, a light-condensing unit that condenses the test light onto the surface to be measured, and a first detector that detects interfering light between the test light Cat's Eye-reflected by the surface to be measured and the reference light reflected by the reference surface;
a driving unit that drives said measurement head along the surface to be measured;
a second detector that detects a position of said measurement head; and
a processor that obtains a Gouy phase generated by diffraction of the test light on the surface to be measured, calculates a phase difference between the test light and the reference light based on information of the interfering light detected by said first detector, and calculates the shape of the surface to be measured from the position of said measurement head detected by said second detector, the obtained Gouy phase, and the calculated phase difference.

2. The apparatus according to claim 1, wherein said driving unit drives said measurement head so as to obtain a constant phase difference between the test light and the reference light calculated by said processor.

3. The apparatus according to claim 1, wherein said driving unit subtracts the obtained Gouy phase from the phase difference between the test light and the reference light calculated by said processor and drives said measurement head so as to obtain a constant phase difference after the subtraction.

4. The apparatus according to claim 1, wherein said driving unit drives said measurement head so that the interfering light detected by said first detector has a constant intensity.

5. The apparatus according to claim 1, wherein the obtained Gouy phase is calculated from one of a designed value of the shape of the surface to be measured and data of the shape of the surface to be measured which is measured in advance.

6. The apparatus according to claim 1, further comprising a Gouy phase controller that controls the Gouy phase,
said Gouy phase controller including at least one of a control mechanism that controls the Gouy phase by controlling a distance between a light-condensing position of the test light on the surface to be measured and a beam waist position of the test light and a control mechanism that controls the Gouy phase by controlling a beam waist diameter of the test light.

7. The apparatus according to claim 1, wherein
the test light includes at least two Gaussian beams of orders that are different from each other,
said first detector detects interfering light between one Gaussian beam reflected by the surface to be measured out of said at least two Gaussian beams and another Gaussian beam, and
said processor obtains the Gouy phase by calculating the Gouy phase using the interfering light between said one Gaussian beam and said other Gaussian beam detected by said first detector.

8. The apparatus according to claim 1, wherein
the test light includes at least two Gaussian beams of orders that are different from each other,
the measurement apparatus further comprises a third detector that detects interfering light between one Gaussian beam reflected by the surface to be measured out of said at least two Gaussian beams and another Gaussian beam, and
said processor obtains the Gouy phase by calculating the Gouy phase using the interfering light detected by said third detector.

9. A method of measuring a shape of a surface to be measured using a measurement apparatus,
the measurement apparatus including:
a measurement head including a division unit that divides light emitted by a light source into reference light and test light, a reference surface that reflects the reference light, a light-condensing unit that condenses the test light onto the surface to be measured, and a first detector that detects interfering light between the test light Cat's Eye-reflected by the surface to be measured and the reference light reflected by the reference surface; and
a second detector that detects a position of the measurement head, the method comprising:
obtaining a Gouy phase generated by diffraction of the test light on the surface to be measured;
causing the first detector to detect the interfering light and causing the second detector to detect the position of the measurement head while driving the measurement head along the surface to be measured; and
calculating a phase difference between the test light and the reference light based on information of the interfering light detected by the first detector, and calculating the shape of the surface to be measured from the position of the measurement head detected by the second detector, the obtained Gouy phase, and the calculated phase difference.

10. The method according to claim 9, wherein the obtained Gouy phase is calculated from one of a designed value of the shape of the surface to be measured and data of the shape of the surface to be measured which is measured in advance.
